(19) United States
(12) Patent Application Publication
(10) Pub. No.: US 2010/0146922 A1
(43) Pub. Date: Jun. 17, 2010

(54) Wound Wire Filter Elements

(75) Inventor: George Greenwood, Tiverton, RI (US)

Correspondence Address: MAURICE M KLEE, 1951 BURR STREET, FAIRFIELD, CT, 06824, US

(73) Assignee: ACS Industries, Inc., Lincoln, RI (US)

(21) Appl. No.: 12/226,125

(22) PCT Filed: Apr. 13, 2007
(86) PCT No.: PCT/US07/09152

§ 371 Date: Oct. 8, 2008

Related U.S. Application Data
(63) Continuation-in-part of application No. 29/259,576, filed on May 11, 2006, now Pat. No. D584390.
(60) Provisional application No. 60/792,153, filed on Apr. 15, 2006.

(51) Int. Cl. B01D 39/10; B01D 39/20; D02G 3/22; B23K 1/20; B65H 81/00; B21F 45/00; B23P 11/00

(52) U.S. Cl. 55/523; 55/525; 55/524; 428/369; 228/173.5; 242/430; 140/71 R; 29/896.62; 29/469; 29/505; 29/902

(57) ABSTRACT

A cylindrical wound wire filter with an inner bore, suitable for use with an airbag inflator, has at least two different outer diameters and/or at least two different inner diameters. Wires in adjacent layers can be bonded together by adhesive or brazing, or have a sheet-like material therebetween, such as a ceramic filter paper.

### BACKGROUND OF THE INVENTION

This invention relates to filter elements and their manufacture by winding a wire about a mandrel.

Filters have long been made by helically winding a strip of material, such as paper or wire, about a form to make a filter. U.S. Pat. No. 2,122,582 describes an intake air filter for an internal combustion engine made by helically winding a gimped wire. Helically wound polymeric fibers have been used to manufacture various filtering or separation apparatus, such as described in U.S. Pat. No. 4,048,074.

In the area of gas generators, such as used to inflate air bags for passenger vehicles, filters are used to control and cool the hot explosion products produced by the gas generator. U.S. Pat. No. 5,230,726 describes a hollow cylindrical core having helically wrapped thereabout various layers of material, including a filter layer; the wrapped core is then cut into filters of the desired size. Ceramic fibers have been helically wrapped about a core to make an air bag inflator filter, as in U.S. Pat. No. 5,702,494 and U.S. Pat. No. 5,908,481. As for wire filters, WO05/065811 describes a filter having copper-plated iron wires knit together and then heat treated between the melting point of copper and its sintering temperature to adhere the wires to each other where they cross. WO05/065999 describes a helically wound wire filter with two layers in which the pitch angles of the first layer superimposed on itself in the radial direction is symmetrical, and a second layer having finer filtration by using a thinner wire.

Winding machines are well-known, from machines for winding wire about pre-stressed pipe having diameters of meters, to machines for winding thread on bobbins or tubes having diameters of centimeters. It is also known to provide computer control for such machines.

There is a need for easier and methods for securing the wound wire to itself, and a need for filters having other than a cylindrical profile or geometry.

### SUMMARY OF THE INVENTION

In light of the foregoing, this invention provides wound wire filters having geometries other than a right rectangular cylinder, wound wire files having improved strength, and wound wire filters having another material provided as a radially intermediate portion disposed between adjacent layers of wires.

This invention provides a cylindrical wound wire filter with an inner bore, suitable for use with an airbag inflator, having at least two different outer diameters and/or at least two different inner diameters. Wires in adjacent layers can be bonded together brazing, or have a sheet-like material therebetween, such as a ceramic filter paper. The brazing material is an example of an adjuvant, which could be an adhesive, or a strip of braided or non-woven material such as the ceramic filter paper fed along with the wire.

In general, this invention provides a wound wire filter having a first inner diameter and a first outer diameter, and at least one second (different) inner diameter (different from the first) or one second (different) outer diameter (different from the first).

### BRIEF DESCRIPTION OF THE DRAWINGS

FIG. 1 depicts the winding device.

FIG. 2 depicts a wound wire filter in a dumbbell shape.

FIG. 3 depicts a cross section of a filter having multiple inner diameters and a sacrificial member.

FIG. 4 depicts the device in FIG. 1 with a set of crimping rolls and an applicator for a paintable or sprayable adjuvant material.

FIGS. 5-7 depict wound wire filter devices having a smooth exterior, a helically-wound interior, and more than one internal diameter.

FIG. 8 depicts a wound wire filter having an expanded metal core.

FIGS. 9A, 9B, and 9C depict, respectively, a side, plan, and perspective views of a filter design made according to this invention.

### DETAILED DESCRIPTION OF SPECIFIC EMBODIMENTS

As noted in the Background, computer-controlled winding machines are known. In one embodiment, this invention uses the computer control in a novel manner to make filters having geometries other than right rectangular cylinders. As shown in FIG. 1, a typical winding machine has a mandrel 1 and a source 2 of an indefinite length material, wire 3 in this invention, that is wound onto the mandrel. For purposes of this invention, the wire is preferably a flat wire, although a round, oval, or any other cross section can be used. The mandrel is preferably a collapsible mandrel, like a chuck for a drill. In these computer-controlled machines, the position L of the source is controlled with respect to the speed of rotation R of the mandrel. The angle α (helix angle) between the wire and the center line (axis of rotation) of the mandrel is typically kept constant and the source moves regularly in one direction, or regularly back and forth shuttling between the ends of the mandrel (or over whatever length is desired to make the part). The dwell time is typically zero at the ends; that is, once the source reaches one end of the mandrel it shuttles back to the other end.

In this invention, the angle α is altered and the movement of the source is varied to achieve a desired geometry. By simple programming, or adjustment of existing computer control, the helix angle and the dwell time are adjusted to make geometries other than a simple right rectangular cylinder. As an alternative to the helix angle, a wind ratio can be specified; the “wind ratio” is the number of windings per linear length taken parallel with the axis of rotation of the mandrel. Because the circumference changes as the wire is wound, a fixed helix angle will result in a changing wind ratio as the device grows, and similarly a fixed wind ratio will result in a changing helix angle as the device grows. The dwell time during a particular axial length can be altered to change the thickness of the wound layer over that length. The apparatus is relatively simple to make from off-the-shelf parts or by modification of a conventional wire winding machine.

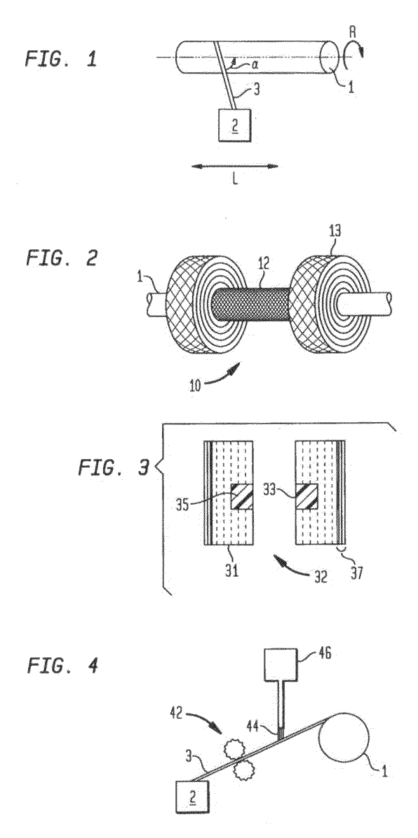

FIG. 2 depicts a wound wire filter 10 in the shape of a dumbbell, having a central cylinder 12 and disk-shaped ends 13 each with a greater radius than the central cylinder. To make such a device, the computer is programmed to wind a central cylindrical portion for the entire length of the filter, then to wind one of the dumbbell ends, then to traverse to the other end and wind that end. If the traverse speed is sufficiently slow, the wire at the outer circumference of the first dumbbell will wind onto the central portion first, and is cosmetically almost indistinguishable from the wires in the central portion. The filter shown in FIG. 2 thus has a geometry other than a simple right rectangular cylinder. Rather, the device as two outer diameters, one for the central portion and one for the dumbbell ends, and a single inner diameter.

These filters can be used for air bag inflators, as are wire mesh filters, such as described in U.S. Pat. No. 6,277,166, the disclosure of which is incorporated herein by reference. In the '166 patent, a wire mesh tube is compressed in a mold to form an annular filter having ribs running axially on the outside of the filter. Using the present invention, a filter having multiple ribs running transversely can be made, effectively like the dumbbell design in FIG. 2 with additional larger disk(s) between the outermost disks (that is, a plurality of two different outer diameters).

In some airbag inflators, the explosive charge is provided in a short length of solid tube, with the ends sealed, and openings around the circumference of the tube for the gases to escape. Using the present invention, a sacrificial band can be placed on the mandrel and a filter wound in the desired geometry. The device is then removed from the mandrel and the band removed. The band can be a polymer, such as neoprene that is removed mechanically or by hand, or polystyrene that is burned off or dissolved chemically, or a water-soluble polymeric compound. As shown in FIG. 3, the resulting filter 31 has a bore 32, a band of sacrificial material 33 forcing the wound material to form a cavity 35. The filter shown in FIG. 3 has a single outer diameter and multiple inner diameters. Surprisingly, it has been found that even the wire is wound under tension, the cavity does not deform to any noticeable extent when the sacrificial material is removed. In use, the cavity acts as a manifold for the explosive gases. Also shown in FIG. 3 is an continuous (axially) outer layer 37, formed by successive windings being side-by-side; that is, the outer layer approximates putting a wound right cylindrical filter into a tube. With the continuous layer, the explosive gases exit axially from the filter.

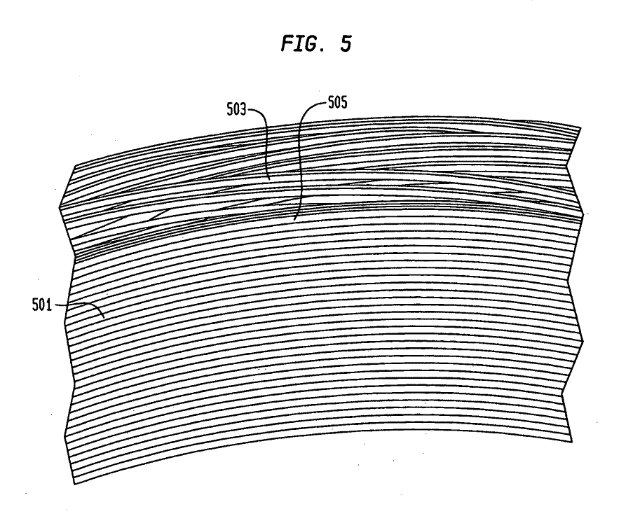

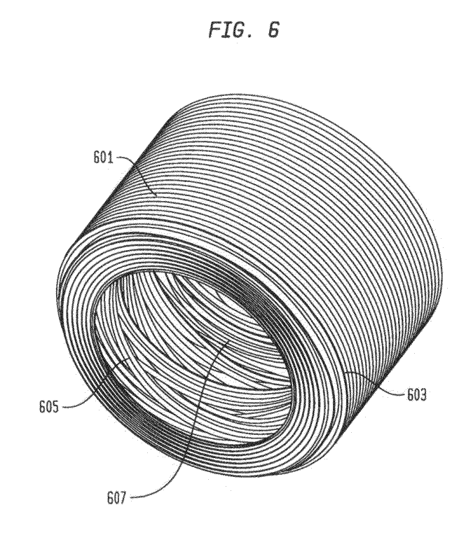

FIG. 4 depicts modifications that can be made to the wire prior to winding. In one embodiment, the wire is passed through a set of crimping rolls 42, so that the wound wire is crimped. It is preferred to place the crimped wire on the outside if the filter is to be placed into a tubular structure; the crimped wire is more compressible (radially) than the uncrimped wire of the bulk filter, so a filter with crimped wire on the outside can be more easily force fit into a cylinder. Likewise, a crimped layer can be formed directly adjacent the mandrel to enable a tubular structure (such as the above mentioned airbag charge) to be forced into the bore of the filter.

Another embodiment shown in FIG. 4 is the application of a adjuvant to the surface of the wire prior to winding. For example, an applicator 44 adjacent the wire is used to apply a paintable or sprayable fluid from a reservoir 46 to the wire. The applicator can be a brush or a spray nozzle. The adjuvant need not be used in combination with crimping, and may be applied to either or both sides of the wire. The adjuvant can be an adhesive, adding shear strength to the wound structure. The adjuvant can be a paste used for brazing. The filter as wound can be sintered to provide a diffusion bond where the wire cross. A stronger bond can be achieved by using a brazing adjuvant, such as copper powder (e.g., 300 mesh) in a vehicle (e.g., propylene glycol). The wires will be brazed and a stronger bond will be formed between crossing wires. It may be desirable to keep the filter on the mandrel during sintering or other heat treatment, in which case the mandrel can be coated with a non-reactive material (e.g., SiN, BN) that will allow the heat-treated filter to be easily removed from the mandrel after the heat treatment.

Similar to applying an adjuvant to the wire, a strip of sheet-like material can be fed along with the wire during winding. Suitable sheet-like materials include braided metal or glass fiber, a non-woven matt (such as glass or carbon fiber, or a ceramic filter paper (such as described in U.S. Pat. No. 4,890,860, and U.S. Pat. No. 6,913,059, the disclosure of which is incorporated herein by reference), stainless steel microfibers (such as in mesh form); the width of the filter paper is preferably wider than the wire width. Using a non-woven strip or filter paper enables filtering relatively finer particles. Depending on the metal used for the wires (stainless steel having heat resistant properties at least at good as SS 309 is preferred for this invention), a pyrolyzable polymeric fiber or strip can be fed in with the wire and the strip pyrolyzed to a ceramic or carbon during heat treatment of the filter.

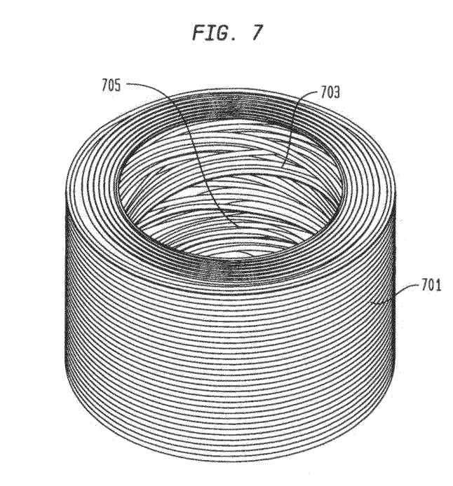

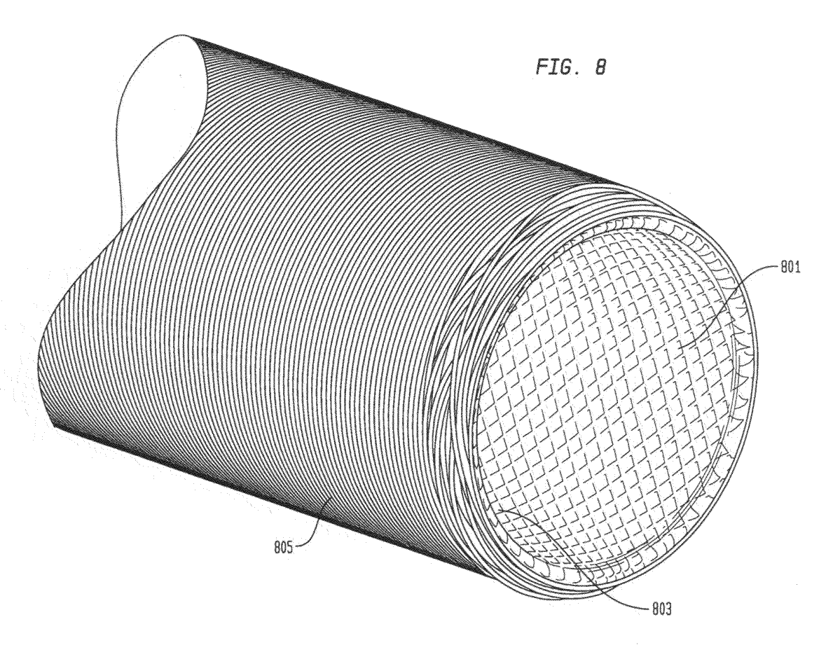

FIGS. 5-7 depict wound wire filter devices having a smooth exterior, where the wire is wrapped side-by-side, an interior where the wire is wrapped helically, and a smaller interior diameter. FIG. 5 is a close up view of a wound wire filter having an innermost diameter 501 wherein the wires are wound side-by-side to make a smooth or flat surface, and intermediate portions where the wire winding changes to helical 503. The innermost surface ends at a shelf 505 that effectively forms a flange on the interior separating a smaller from a larger ID of the device. FIG. 6 depicts a similar device, where the outer surface 601 of the filter is smooth (side-by-side winding) and ends 603 at a small shelf where the winding becomes helical 605, as seen on the larger diameter interior surface. A smaller diameter interior diameter, as in FIG. 5, ends at another shelf 607. FIG. 7 is another perspective view of a similar device having a smooth outer surface 701 overlying a helically-wound interior 703, the device having both a larger diameter inner diameter (ID) at 703 and a smaller diameter ID ending at shelf 705. From the devices seen in FIGS. 5-7 is can be seen that a wound filter can be made with multiple inner and/or outer diameters, and that the innermost and/or outermost surfaces can be made with a smooth winding (i.e., side-by-side winding) or more porous with helical winding.

In another embodiment, an expanded metal sleeve can be positioned on the inner diameter and/or the outer diameter. The axial strength of the filter can be augmented by orienting the diamond-shaped opening of the expanded metal sleeve along the axis of the filter. In addition, if the thickness of the sleeve is thicker than the thickness of the wire used for winding, then the sleeve acts as a heat sink, protecting the smaller wires. The expanded metal sleeve can be manufactured from carbon steel, stainless steel, or any other metallic substance. The sleeve can be in place if the device is sintered, whereby the sleeve will become fused with any wires with which it is in contact.

In another embodiment, a wire winding on a mandrel can be paused at one end of the unfinished winding, an insert placed over the existing winding, and then the winding continued to effectively encase the insert between relatively inner and outer windings. This operation can be done multiple times, and can include in inner porous sleeve like the expanded metal sleeve described above. The insert can be in the form of a porous sheet (metal or polymeric, including weaves like screens and fabric), a preformed tube (like an expanded metal tube), a mesh (plastic or metal, preferably knitted), or any combination.

In the foregoing embodiments, the filter preferably has an internal diameter of about one to three inches (2.5-7.5 cm) and a length of about one to two inches (20-50 cm), suitable for installation in the steering wheel of a vehicle as part of a driver's side airbag. A filter for the airbag safety device on the passenger's side is typically much longer (about 12-18 cm) and has a smaller diameter (about 15-40 cm). The airbag curtain device that protects against contact with the side window has an even smaller inner diameter (5-20 mm) and length (about 20-30 mm). The thickness of the filter depends on the particular application and the charge used. Front (driver and passenger) airbags typically use an explosive material for the charge, whereas side (curtain) airbags use either an explosive charge ignited during a collision or a stored gas canister ruptured to release the gas in a collision.

A front airbag for the passenger side of a vehicle typically is much larger than the driver's front airbag, and so more gas generation is required. Where a driver's front airbag device may include a single charge, the passenger's front airbag may have up to five equivalent charges, including charges of different sizes (not all of which are ignited, as in “smart” airbag technology where the weight of the passenger is sensed to determine the explosive force needed). Because of the interior design of vehicles, the passenger's front airbag must cover a far greater portion of the dashboard than the driver's front airbag (which essentially protects the driver from the steering wheel). Accordingly, the devices, and hence the filters, are much longer, as described above.

In another embodiment, this invention provides a filter especially useful for a passenger's front airbag, wherein the wire is wound around a hollow core having a multiplicity of openings. The core can be any material that will withstand the explosion and provides filtering. A woven or knitted wire mesh can be used as the core. A woven metal wire sheet or screen is rolled into a tube or cylinder and welded with abutting ends. A wire mesh is typically knitted as a tube, and where knitted wires are overlapping they can be spot welded to give the mesh integrity; thereafter, the mesh can be cut to the desired tube length. Another alternative is an expanded metal sheet; like a woven sheet, the expanded metal sheet is cut to size and welded with abutting edges to provide a cylinder. Because the explosion is essentially isotropic, and wire is wound around the core, abutting edges are preferred to overlapping edges. As shown in FIG. 8, an expanded metal sheet is rolled into a cylinder and welded with abutting edges to provide a core 801. Each end 803 of the core is preferably flared out. The core is then placed on a mandrel, and the wire 805 is wrapped around the core to provide the filter. As with the filters described above, the end of the wire is preferably spot welded to the winding and then broken off to assure the wire does not ravel (unwind). As described above, the wound wire can be made to provide various patterns or structures in the winding. The core is preferably made of stainless steel, has a thickness of about 0.1 mm to about 1.0 mm (in the figure the thickness is about 0.5 mm) and has about 5% to about 50% void space (i.e., the multiplicity of opening as a fraction of the area of one side).

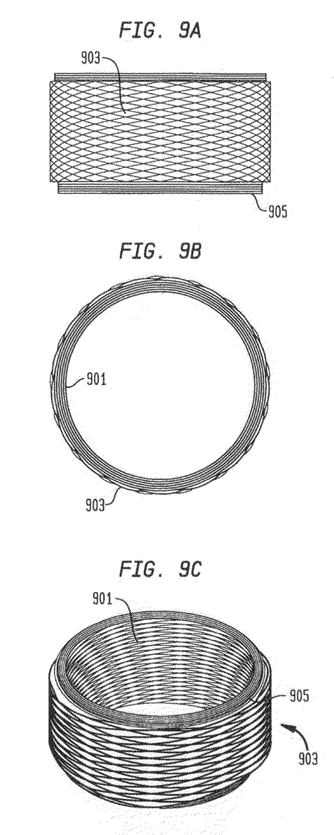

FIGS. 9A-9C are side, plan, and perspective views of a filter wherein the inner surface 901 is relatively smooth and the outer surface 903 is made using a relatively large angle so that the helical winding provides a relatively open pattern. In comparison with the shelf shown in FIG. 6, the shelf 905 is more sharply defined due to the winding pattern shown in these figures, and thus forms a flange with good tolerance for mating with the housing in which the filter will be used.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. A wound wire filter made from a continuous single wire and having a first inner diameter and a first outer diameter, and at least one of a second inner diameter and a second outer diameter different from the respective first diameter.

2. The filter of claim 1, comprising two second outer diameters.

3. A wound wire filter wherein wires on adjacent layers are bonded to each other.

4. The filter of claim 3, wherein the wire are bonded by brazing.

5. The filter of claim 3, wherein the wires are bonded by adhesive.

6. A wound wire filter, wherein at least a portion of the winding comprises a strip of sheet-like material present adjacent the wire throughout at least a portion of the wound wire.

7. The filter of claim 6, wherein the sheet-like material is a braided metal.

8. The filter of claim 6, wherein the sheet-like material is ceramic filter paper.

9. The filter of claim 1, comprising a first and a second inner diameter, and further comprising a continuous outer layer.

10. A method for making a filter, comprising: winding a wire around a mandrel to produce an annular device having an innermost and an outermost diameter, and altering the helix angle α, the dwell, and the position of the wire to be wound effective to produce a filter having at least two inner diameters or at least two outer diameters.

11. The method of claim 10, further comprising altering the helix angle effective to provide a smooth surface on the interior of the fitter or the exterior of the filter.

12. The method of claim 10, further comprising applying to the wire prior to winding a brazing material.

13. The method of claim 10, further comprising winding the wire adjacent a sheet-like material.

14. A wound wire filter, comprising: a hollow cylindrical core having a multiplicity of openings; and a continuous single wire wound about the core along the length of the core.

15. The filter of claim 14, wherein the core is an expanded metal sheet rolled into a cylinder and welded with abutting edges.

16. The filter of claim 14, wherein the ends of the core are flared radially outwards.

17. The filter of claim 14, wherein the hollow cylindrical core is disposed between inner windings and outer windings.

18. The fitter of claim 14, wherein the hollow cylindrical core is a mesh or weave made from metal or plastic.
